(19) United States
(12) Patent Application Publication
(10) Pub. No.: US 2026/0118119 A1
(43) Pub. Date: Apr. 30, 2026

(54) ROAD SURFACE CONDITION DETERMINING METHOD AND ROAD SURFACE CONDITION DETERMINING DEVICE

(71) Applicant: The Yokohama Rubber Co., LTD., Kanagawa (JP)

(72) Inventors: Naoshi MIYASHITA, Kanagawa (JP); Haruna WAKABAYASHI, Kanagawa (JP)

(21) Appl. No.: 19/145,133

(22) PCT Filed: Dec. 25, 2023
(86) PCT No.: PCT/JP2023/046422

§ 371 Date: Jul. 1, 2025

(30) Foreign Application Priority Data
Jan. 6, 2023 (JP) 2023-001099

(51) Int. Cl. G01B 21/30; B60C 19/00; G07C 5/04

(52) U.S. Cl. CPC G01B 21/30; B60C 19/00; G07C 5/04; B60C 2019/004

(57) ABSTRACT

A road surface condition determining method and a road surface condition determining device. A road surface condition determining method includes: a first step of acquiring over time a signal including information on acceleration, a strain rate, or strain output from a sensor disposed on an inner surface of a tire when the tire rolls on a road surface and obtaining time-series data X(t) when the tire has rotated at least twice; a second step of obtaining an autocorrelation function R(τ), where τ is time, from the time-series data X(t) obtained in the first step; a third step of extracting positive local maximum values having a predetermined magnitude or more at τ>0 for the autocorrelation function R(τ) obtained in the second step; and a fourth step of determining unevenness of the road surface by using the positive local maximum values extracted in the third step.

### TECHNICAL FIELD

The present invention relates to a road surface condition determining method and a road surface condition determining device that use a sensor provided on an inner surface of a tire and relates particularly to a road surface condition determining method and a road surface condition determining device for determining unevenness of a road surface.

### BACKGROUND ART

Conventionally, it has been attempted to estimate a condition of a road surface on which an automobile (vehicle) is traveling by using a measurement waveform from a sensor mounted on an inner surface of a tire.

For example, Patent Document 1 proposes a road surface condition estimation method for estimating a condition of a road surface on which a tire is traveling, from a time-varying waveform of vibration of the tire during travel detected by a vibration detection means.

In Patent Document 1, an acceleration sensor is disposed in a tire to detect vibration of the tire during travel, a position of a step-in point and a position of a kick-out point of the tire are estimated from a peak position appearing in a time-varying waveform of the vibration, a step-in/kick-out position determination is performed to determine whether or not the estimated position of the step-in point and the estimated position of the kick-out point are the actual position of the step-in point and the actual position of the kick-out point by using one or more of a ground contact time, a non-ground contact time, and a rotation time of the tire calculated from the estimated position of the step-in point and the estimated position of the kick-out point, the road surface condition is not estimated when the determination result of the step-in/kick-out position determination indicates erroneous estimation, and the road surface condition is estimated when the determination result of the step-in/kick-out position determination is within a normal range. The position of the step-in point and the position of the kick-out point are the actual position of the step-in point and the actual position of the kick-out point, and the road surface condition is estimated by using the vibration levels in a step-in region and a kick-out region.

### CITATION LIST

### Patent Literature

Patent Document 1: JP 2015-168362 A

### SUMMARY OF INVENTION

### Technical Problem

As described above, in Patent Document 1, the road surface condition is estimated by using the vibration levels in the step-in region and the kick-out region, and the road surface condition is determined on a spatial scale shorter than the ground contact length of the tire or the circumferential length of the tire. However, there is no method for determining the road surface condition on a spatial scale longer than the ground contact length of the tire or the circumferential length of the tire.

An object of the present invention is to provide a road surface condition determining method and a road surface condition determining device capable of determining a road surface condition on a spatial scale longer than a ground contact length of a tire or a circumferential length of the tire.

### Solution to Problem

In order to achieve the above object, the invention [1] is a road surface condition determining method including: a first step of acquiring over time a signal including information on acceleration, a strain rate, or strain output from a sensor disposed on an inner surface of a tire when the tire rolls on a road surface and obtaining time-series data X(t) when the tire has rotated at least twice: a second step of obtaining an autocorrelation function R(τ), where t is time, from the time-series data X(t) obtained in the first step: a third step of extracting positive local maximum values having a predetermined magnitude or more at τ>0 for the autocorrelation function R(τ) obtained in the second step: and a fourth step of determining unevenness of the road surface by using the positive local maximum values extracted in the third step.

The invention [2] is the road surface condition determining method according to the invention [1], wherein the fourth step includes determining the unevenness of the road surface by using a positive local maximum value closest to τ=0 in the autocorrelation function R(τ) among the positive local maximum values extracted in the third step.

The invention [3] is the road surface condition determining method according to the invention [1] or [2], wherein positions of the positive local maximum values extracted in the third step are compared with a rotation period of the tire acquired by a measurement device other than the sensor: the fourth step of determining the unevenness of the road surface is performed when the positions of the positive local maximum values extracted are appropriate for the rotation period of the tire; and the positive local maximum values are not used for the fourth step of determining the unevenness of the road surface when the positions of the positive local maximum values extracted are inappropriate for the rotation period of the tire.

The invention [4] is the road surface condition determining method according to any one of the inventions [1] to [3], wherein time-series data X(t) having a length equal to an integral multiple of a rotation period of the tire is used.

The invention [5] is the road surface condition determining method according to any one of the inventions [1] to [4], wherein the positive local maximum values extracted in the third step are 0.1 or more.

The invention [6] is the road surface condition determining method according to any one of the inventions [1] to [5], wherein a plurality of the sensors are disposed evenly in a circumferential direction of the tire, and the first step includes obtaining the time-series data X(t) by summing up the signal including the information on the acceleration, the strain rate, or the strain from each of the sensors.

The invention [7] is the road surface condition determining method according to any one of the inventions [1] to [6], wherein a plurality of the tires are provided, and the sensor is provided in each of the tires.

The invention [8] is a road surface condition determining device including: a sensor disposed on an inner surface of a tire when the tire rolls on a road surface: an acquisition unit configured to acquire over time a signal including information on acceleration, a strain rate, or strain output from the sensor and obtain time-series data X(t) when the tire has rotated at least twice: a processing unit configured to obtain an autocorrelation function R(τ), where τ is time, from the time-series data X(t) obtained by the acquisition unit and extract positive local maximum values having a predetermined magnitude or more at τ>0 for the obtained autocorrelation function R(τ); and a determination unit configured to determine unevenness of the road surface by using the positive local maximum values extracted by the processing unit.

The invention [9] is the road surface condition determining device according to the invention [8], wherein the determination unit determines the unevenness of the road surface by using a positive local maximum value closest to τ=0 in the autocorrelation function R(τ) among the positive local maximum values extracted by the processing unit.

The invention is the road surface condition determining device according to the invention [8] or [9], wherein positions of the positive local maximum values extracted by the processing unit are compared with a rotation period of the tire acquired by a measurement device other than the sensor, the determination unit determines the unevenness of the road surface when the positions of the positive local maximum values extracted are appropriate for the rotation period of the tire, and the positive local maximum values are not used for the determination unit to determine the unevenness of the road surface when the positions of the positive local maximum values extracted are inappropriate for the rotation period of the tire.

The invention is the road surface condition determining device according to any one of the inventions [8] to [10], wherein time-series data X(t) having a length equal to an integral multiple of a rotation period of the tire is used.

The invention is the road surface condition determining device according to any one of the inventions [8] to [11], wherein the positive local maximum values extracted by the processing unit are 0.1 or more.

The invention is the road surface condition determining device according to any one of the inventions [8] to [12], wherein a plurality of the sensors are disposed evenly in a circumferential direction of the tire, and the acquisition unit obtains the time-series data X(t) by summing up the signal including the information on the acceleration, the strain rate, or the strain from each of the sensors.

The invention is the road surface condition determining device according to any one of the inventions [8] to [13], wherein a plurality of the tires are provided, and the sensor is provided in each of the tires.

### Advantageous Effects of Invention

According to the present invention, it is possible to determine a road surface condition on a spatial scale longer than the ground contact length of a tire or the circumferential length of the tire.

### BRIEF DESCRIPTION OF DRAWINGS

FIG. 1 is a schematic diagram illustrating an example of a vehicle that is used in a road surface condition determining method according to an embodiment of the present invention.

FIG. 2 is a schematic diagram illustrating an example of a road surface condition determining device that is used in the road surface condition determining method according to the embodiment of the present invention.

FIG. 3 is a flowchart illustrating a first example of the road surface condition determining method according to the embodiment of the present invention.

FIG. 4(a) is a graph indicating an example of time-series data X(t) from a sensor on a flat road surface, and FIG. 4(b) is a graph indicating an example of an autocorrelation function of the time-series data X(t) of FIG. 4(a).

FIG. 5(a) is a graph indicating an example of time-series data X(t) from a sensor on an uneven road surface, and FIG. 5(b) is a graph indicating an example of an autocorrelation function of the time-series data X(t) of FIG. 5(a).

FIGS. 6(a) to 6(c) are each a graph for explaining an example of a method of obtaining an autocorrelation function from the time-series data X(t).

FIG. 7 is a graph indicating an example of time-series data X(t) for two revolutions of a tire.

FIG. 8 is a flowchart illustrating a second example of the road surface condition determining method according to the embodiment of the present invention.

FIG. 9 is a schematic diagram illustrating an example of a tire in which three sensors are disposed.

FIG. 10(a) is a graph indicating an example of time-series data obtained by a first sensor, FIG. 10(b) is a graph indicating an example of time-series data obtained by a second sensor, FIG. 10(c) is a graph indicating an example of time-series data obtained by a third sensor, and FIG. 10(d) is a graph indicating an example of a composite waveform of the time-series data obtained by the first sensor to the time-series data obtained by the third sensor.

FIG. 11(a) is a graph indicating a first example of an output of a sensor, FIG. 11(b) is a graph indicating a second example of an output of a sensor, and FIG. 11(c) is a graph indicating a third example of an output of a sensor.

FIG. 12 is a schematic cross-sectional view illustrating an attachment position of a sensor in a tire.

FIG. 13(a) is a graph indicating time-series data X(t) from a sensor on a flat road surface in Example 1, and FIG. 13(b) is a graph indicating an autocorrelation function of the time-series data X(t) of FIG. 13(a).

FIG. 14(a) is a graph indicating time-series data X(t) from a sensor on an uneven road surface in Example 1, and FIG. 14(b) is a graph indicating an autocorrelation function of the time-series data X(t) of FIG. 14(a).

### DESCRIPTION OF EMBODIMENTS

A road surface condition determining method and a road surface condition determining device according to the present invention will be described in detail below on the basis of a preferred embodiment illustrated in the attached drawings.

The drawings described below are merely examples for explaining the present invention, and the present invention is not limited to the drawings given below.

In addition, in the following description, an angle such as “an angle represented by a specific numerical value” and “orthogonal” includes an error range generally allowed in the relevant technical field unless otherwise specified.

In addition, numerical values also include an error range generally allowed in the relevant technical field unless otherwise specified.

### Road Surface Condition Determining Device

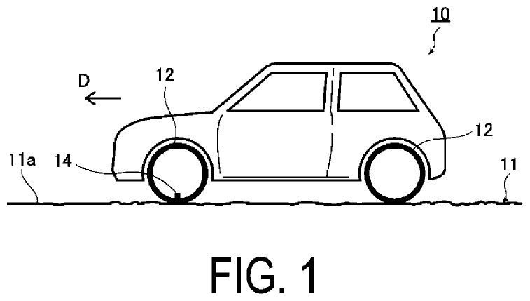

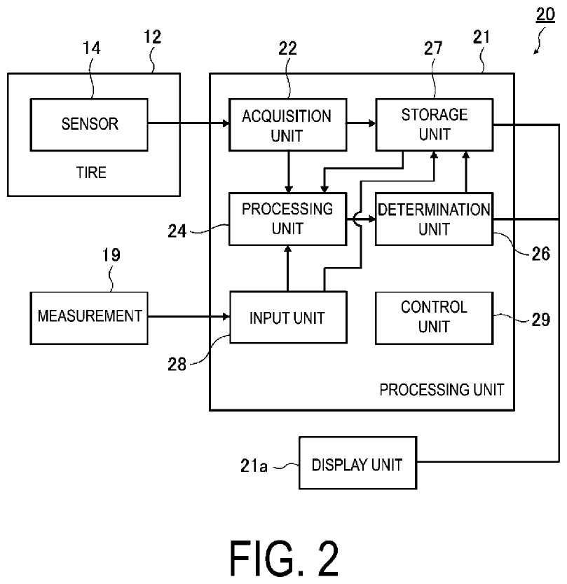

FIG. 1 is a schematic diagram illustrating an example of a vehicle that is used in a road surface condition determining method according to an embodiment of the present invention. FIG. 2 is a schematic diagram illustrating an example of a road surface condition determining device that is used in the road surface condition determining method according to the embodiment of the present invention.

For example, as illustrated in FIG. 1, a sensor 14 is disposed in a tire 12 attached to a vehicle 10. The vehicle 10 moves on a surface 11a of a road surface 11 in, for example, a traveling direction D. In this event, the tire 12 rolls.

In the road surface condition determining method and the road surface condition determining device, the road surface condition is determined when the tire 12 rolls on the road surface 11. The determination of the road surface condition is made by quantifying uneven ground information on the road surface 11 on a spatial scale longer than the circumferential length of the tire 12, and the road surface condition is not determined for the unevenness of the road surface on a spatial scale shorter than the circumferential length of the tire. The road surface condition determining method and the road surface condition determining device can determine the road surface condition in a range equal to or larger than the range in contact with the tire. As is well known, the circumferential length of the tire is longer than the ground contact length of the tire.

A road surface condition determining device 20 illustrated in FIG. 2 is used in the road surface condition determining method. The road surface condition determining method is not limited to the use of the road surface condition determining device 20 illustrated in FIG. 2.

The road surface condition determining device 20 illustrated in FIG. 2 includes the sensor 14 provided in the tire 12, a processing unit 21, and a display unit 21a.

The processing unit 21 includes an acquisition unit 22, a processing unit 24, a determination unit 26, a storage unit 27, an input unit 28, and a control unit 29. The acquisition unit 22, the processing unit 24, the determination unit 26, the storage unit 27, and the input unit 28 are all controlled by the control unit 29.

The acquisition unit 22 is connected to the sensor 14. The acquisition unit 22 acquires over time a signal including information on acceleration, a strain rate, or strain output from the sensor 14 disposed on the inner surface of the tire 12 when the tire 12 rolls on a road surface, and obtains time-series data X(t) when the tire 12 has rotated at least twice output from the sensor 14. The letter t in the time-series data X(t) denotes time.

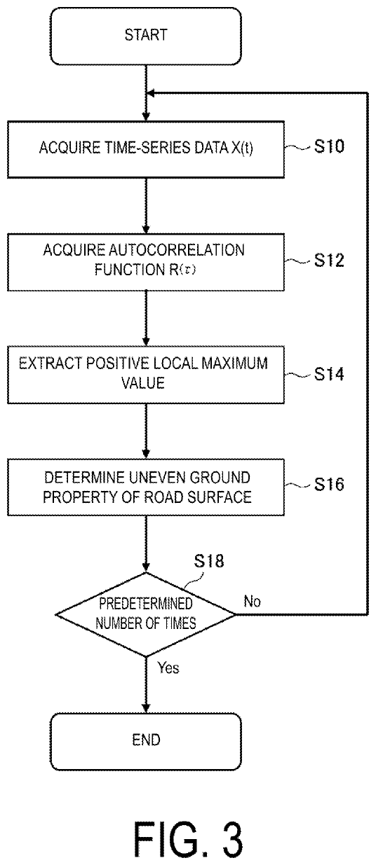

The acquisition unit 22 performs step S10 (see FIG. 3, first step) described later.

The acquisition unit 22 and the sensor 14 are, for example, wirelessly connected, and the acquisition unit 22 receives the signal output from the sensor 14 over time and acquires the above-described signal over time.

The wireless connection between the acquisition unit 22 and the sensor 14 is not particularly limited, and a known wireless connection can be used as appropriate.

The processing unit 24 obtains an autocorrelation function R(τ), where τ is time, from the time-series data X(t) obtained by the acquisition unit 22 and extracts positive local maximum values having a predetermined magnitude or more at τ>0 for the obtained autocorrelation function R(τ).

The processing unit 24 performs step S12 (see FIG. 3, second step) and step S14 (see FIG. 3, third step), which will be described later.

The processing unit 24 also performs a step (step S15 (see FIG. 3)) of comparing the rotation period of the tire 12 acquired by a measurement device other than the sensor 14 (see FIG. 1) described later. Step S15 described later is not necessarily performed.

The determination unit 26 determines the unevenness of the road surface on a spatial scale longer than the circumferential length of the tire by using the positive local maximum values extracted by the processing unit 24.

The road surface condition determining device 20 can determine the unevenness of the road surface on a spatial scale longer than the circumferential length of the tire by using the positive local maximum values.

The time-series data X(t), the autocorrelation function R(τ), the positive local maximum values, and the determination of the unevenness of the road surface will be described later.

The storage unit 27 is connected to the acquisition unit 22, the processing unit 24, the determination unit 26, and the input unit 28. For example, the storage unit 27 stores a signal including information on the speed, the strain speed, or the strain acquired by the acquisition unit 22, and the time-series data X(t) when the tire 12 has rotated at least twice.

The determination result of the determination unit 26 is also stored. The information input to the input unit 28 is also stored.

The input unit 28 is connected to the measurement unit 19. The measurement unit 19 measures the vehicle speed of the vehicle 10 (see FIG. 1). The measurement unit 19 is not particularly limited as long as the measurement unit 19 can measure the vehicle speed, and includes, for example, a wheel speed sensor that measures the rotation speed of a wheel of the vehicle.

The information on the vehicle speed is input from the measurement unit 19 to the input unit 28, and the information on the vehicle speed is stored in the storage unit 27.

The measurement unit 19 is an example of a measurement device other than the sensor 14 (see FIG. 1). The measurement device other than the sensor 14 (see FIG. 1) is not limited to the measurement unit 19 as long as the measurement device can measure the vehicle speed and the like. For example, the vehicle speed may be obtained by using position information on the vehicle obtained through a GPS (Global Positioning System).

The processing unit 24 may use a signal including information on the speed, the strain speed, or the strain and time-series data X(t) when the tire 12 has rotated at least twice stored in the storage unit 27, instead of the acquisition unit 22.

The processing unit 24 can also use information on the vehicle speed input to the input unit 28 or information on the vehicle speed stored in the storage unit 27.

The determination of the unevenness of the road surface obtained by the determination unit 26 can also be stored in the storage unit 27.

The determination of the unevenness of the road surface can be displayed as an image on a screen (not illustrated) of the display unit 21a. The display unit 21a may display the time-series data X(t), the autocorrelation function R(τ), the positive local maximum values, and the vehicle speed.

The display unit 21a is not particularly limited, and various known displays such as liquid crystal displays can be used.

The processing unit 21 of the road surface condition determining device 20 may be constituted by a computer in which each part functions by executing a program (computer software) stored in a ROM (Read Only Memory) or the like, may be a dedicated device in which each part is constituted by a dedicated circuit, or may be constituted by a server so as to be executed on a cloud.

### First Example of Road Surface Condition Determining Method

Next, a first example of the road surface condition determining method will be described.

FIG. 3 is a flowchart illustrating a first example of the road surface condition determining method according to the embodiment of the present invention.

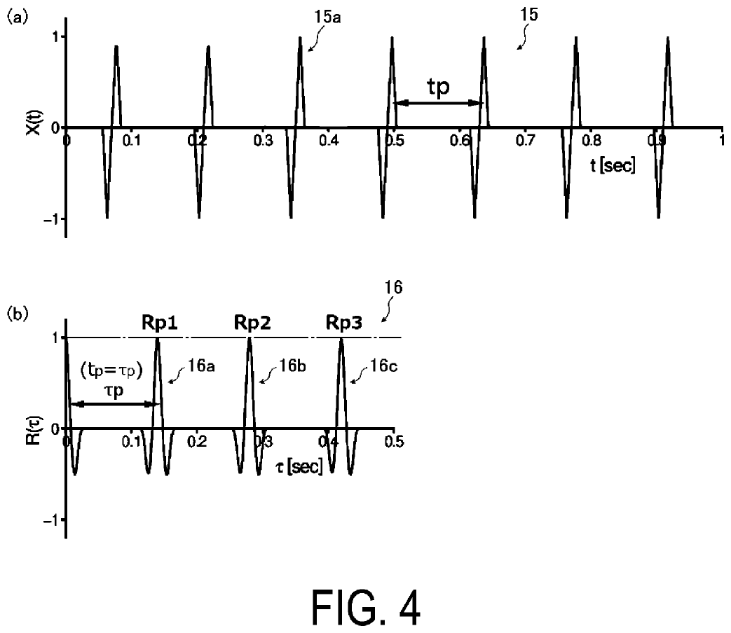

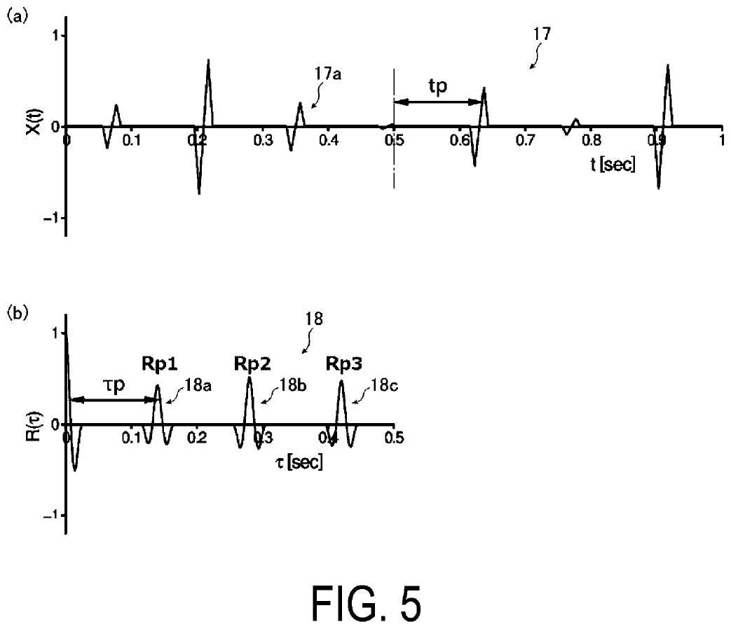

FIG. 4(a) is a graph indicating an example of time-series data X(t) from a sensor on a flat road surface, and FIG. 4(b) is a graph indicating an example of an autocorrelation function of the time-series data X(t) of FIG. 4(a). FIG. 5(a) is a graph indicating an example of time-series data X(t) from a sensor on an uneven road surface, and FIG. 5(b) is a graph indicating an example of an autocorrelation function of the time-series data X(t) of FIG. 5(a). FIG. 4(a) and FIG. 5(a) indicate time-series data X(t) based on a signal including information on a strain rate among signals including information on acceleration, the strain rate, or strain.

Although the time-series data X(t) will be described by using a signal including information on a strain rate as an example among signals including information on acceleration, the strain rate, or strain, a signal including information on acceleration or strain can also provide the same result as that of the signal including information on the strain rate.

In the first example of the road surface condition determining method, the above-described road surface condition determining device 20 is used, for example.

When the tire 12 (see FIG. 1) rolls on the road surface 11 (see FIG. 1), a signal including information on acceleration, a strain rate, or strain, which is output from the sensor 14 (see FIG. 1) disposed on the inner surface of the tire 12, is acquired over time. A first step of obtaining time-series data X(t) when the tire 12 has rotated at least twice is performed (step S10).

The time-series data X(t) when the tire 12 has rotated at least twice is, for example, a continuous ground contact waveform group 15 indicated in FIG. 4(a) and a continuous ground contact waveform group 17 indicated in FIG. 5(a).

The continuous ground contact waveform group 15 indicated in FIG. 4(a) has a plurality of ground contact waveforms 15a and is an example of the time-series data X(t) on a flat road surface. The interval of the ground contact waveform 15a is tp. The interval tp indicates the rotation period of the tire.

The continuous ground contact waveform group 17 indicated in FIG. 5(a) has a plurality of ground contact waveforms 17a and is an example of the time-series data X(t) on an uneven road surface. The interval of the ground contact waveform 17a is tp.

Next, a second step of obtaining an autocorrelation function R(τ), where tis time, from the time-series data X(t) obtained in the first step (step S10) is performed (step S12).

By the second step (step S12), an autocorrelation function 16 indicated in FIG. 4(b) is obtained from the continuous ground contact waveform group 15 indicated in FIG. 4(a). FIG. 4(b) indicates three waveforms 16a, 16b, and 16c of the autocorrelation function 16.

Further, an autocorrelation function 18 indicated in FIG. 4(b) is obtained from the continuous ground contact waveform group 17 indicated in FIG. 5(a). FIG. 5(b) indicates three waveforms 18a, 18b, and 18c of the autocorrelation function 18.

Next, a third step of extracting positive local maximum values having a predetermined magnitude or more at τ>0 from the autocorrelation function R(τ) obtained in the second step is performed (step S14).

For example, positive local maximum values of a predetermined magnitude are extracted from the three waveforms 16a, 16b, and 16c indicated in FIG. 4(b). For a flat road surface, positive local maximum values Rp1, Rp2, and Rp3 of the three waveforms 16a, 16b, and 16c indicated in FIG. 4(b) are extracted. For a flat road surface, the positive local maximum values Rp1, Rp2, and Rp3 are all 1. This is because, for a flat road surface, the ground contact waveform next to the ground contact waveform 15a of the ground contact waveform group 15 indicated in FIG. 4(a) and the ground contact waveform next to the next ground contact waveform are not changed. That is, for a flat road surface, the change in the ground contact waveforms is small in time series. When the positive local maximum values are 1, the ground contact waveform is the same as the adjacent ground contact waveform, and thus the road surface is completely flat.

For an uneven road surface, a positive local maximum value Rp1 of the three waveforms 18a, 18b, and 18c indicated in FIG. 5(b) is extracted. For an uneven road surface, the positive local maximum values Rp1, Rp2, and Rp3 are all smaller than 1. This is because, for an uneven road surface, which is not a flat road surface, the values of the autocorrelation function change as the ground contact waveform 17a of the ground contact waveform group 17 indicated in FIG. 5(a) changes in time series. It is indicated that as the positive local maximum value Rp1 is smaller, the difference from the adjacent ground contact waveform is larger, which means that the unevenness of the road surface is larger. The lower limit value of the positive local maximum value is zero.

The method of extracting a positive local maximum value is not particularly limited, and a known method of extracting a local maximum value can be used. Alternatively, for example, a threshold value is set, and the values of the autocorrelation function are examined along the time axis from time zero (τ=0) to extract values larger than the threshold value. A pattern in which the value increases and then decreases after a peak value is detected from the extracted values. The peak value of this pattern may be a positive local maximum value.

The positive local maximum value is set to have a predetermined magnitude or more in order to avoid extraction of a noise peak near the baseline. Therefore, in order to prevent the erroneous extraction of the positive local maximum value, the positive local maximum value extracted in the third step is preferably 0.1 or more. The upper limit value of the positive local maximum value is 1.

Next, a fourth step of determining the unevenness of the road surface by using the positive local maximum values extracted in the third step (step S14) is performed (step S16).

As described above, the positive local maximum values Rp1, Rp2, and Rp3 are all 1 for a flat road surface, and the positive local maximum values Rp1, Rp2, and Rp3 are all smaller than 1 for an uneven road surface. As described above, it is meant that as the positive local maximum value Rp1 is smaller, the unevenness of the road surface is larger. The unevenness of the road surface is determined by using this feature. As described above, when the positive local maximum value is 1, the ground contact waveform is the same as the adjacent ground contact waveform, and thus the road surface is completely flat.

In this way, in the first example of the road surface condition determining method, the unevenness of the road surface on a spatial scale longer than the circumferential length of the tire can be determined by using the positive local maximum value.

Since the positive local maximum value Rp1 is a value of the autocorrelation function, the positive local maximum value becomes smaller when the road surface changes to a convex shape or a concave shape as the road surface condition.

The positive local maximum value may also become smaller when the vehicle speed changes, that is, when the vehicle accelerates or decelerates. Therefore, the vehicle speed is preferably constant when the unevenness of the road surface is determined.

The positive local maximum value closest to τ=0 in the autocorrelation function R(τ) has high accuracy of the autocorrelation function and can increase the accuracy of the determination of the unevenness of the road surface. Therefore, it is preferable to use the positive local maximum value closest to τ=0 for the determination of the unevenness of the road surface. That is, it is preferable to use the positive local maximum value Rp1 of the waveform 16a in FIG. 4(b) and the positive local maximum value Rp1 of the waveform 18a in FIG. 5(b). The positive local maximum value closest to τ=0 is the first waveform of the autocorrelation function.

If the statistical accuracy of the time-series data X(t) is sufficient, the second and subsequent positive local maximum values may be used for the determination of the unevenness of the road surface.

After the fourth step, the number of times of the determination of the unevenness of the road surface is set in advance, the set number of times is determined, and the determination of the unevenness of the road surface is repeatedly performed when the number of times of the determination of the unevenness of the road surface has not reached the set number of times (step S18). The set number of times may not be set.

By setting the number of times of the determination of the unevenness of the road surface (step S18), the determination of the unevenness of the road surface can be continuously performed, and the unevenness of the road surface can be determined over a long range.

In the first example of the road surface condition determining method, the time-series data X(t), the autocorrelation function R(τ), the value of the positive local maximum value, and the determination result of the unevenness of the road surface may be displayed on the display unit 21a of the road surface condition determining device 20 described above, for example.

Next, a method of obtaining an autocorrelation function will be described.

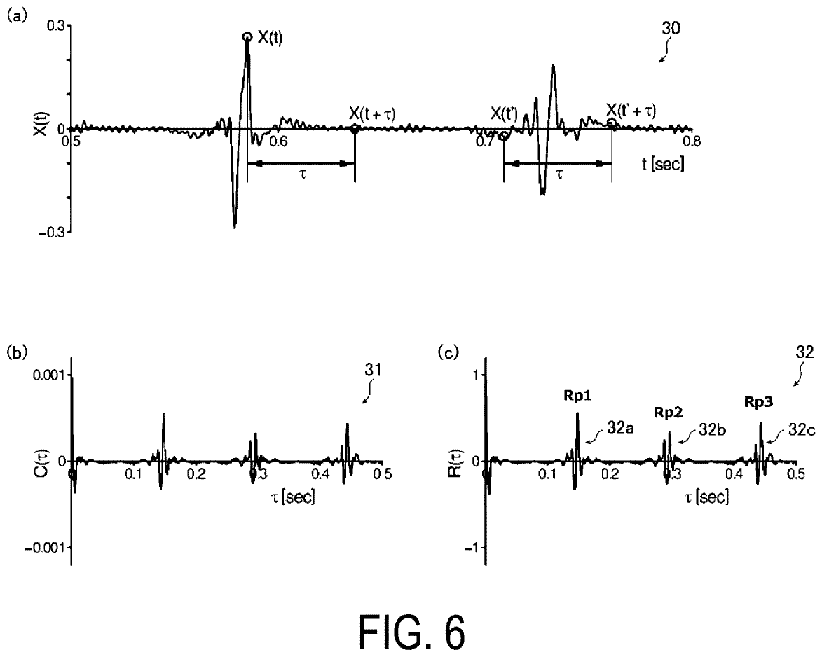

FIGS. 6(a) to 6(c) are each a graph for explaining an example of a method of obtaining an autocorrelation function from the time-series data X(t).

For a continuous ground contact waveform group 30 indicating the time-series data X(t) when having rotated at least twice indicated in FIG. 6(a), all combinations of signals separated by the time t are extracted, and an average (ensemble average) of the multiplication is obtained. Consequently, a waveform 31 of a covariance C (t) indicated in FIG. 6(b) is obtained.

$$The covariance C ( τ ) is expressed by convariance$$

$$C ( τ ) = < X ( t ) \times ( t + τ ) > .$$

Next, the waveform 31 of the covariance C (t) is normalized by the value (that is, C(0)) at time zero (τ=0), and thereby the autocorrelation function R(τ) is obtained. An autocorrelation function 32 indicated in FIG. 6(c) is obtained. Three waveforms 32a, 32b, and 32c are indicated in the autocorrelation function 32.

The autocorrelation function is expressed as R(τ)=C(τ)/C(0). Since the autocorrelation function handles a time series of a finite width, the number of combinations that can be extracted decreases as the time t increases, and the evaluation accuracy of the autocorrelation function R(τ) may decrease.

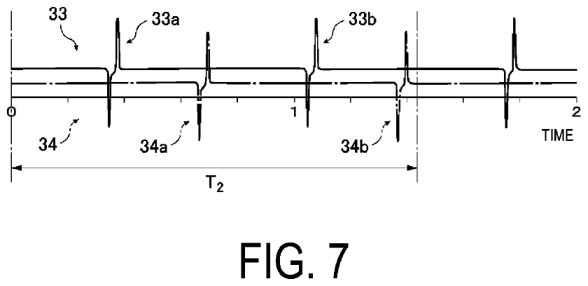

Here, FIG. 7 is a graph indicating an example of the time-series data X(t) for two revolutions of a tire.

FIG. 7 indicates two continuous ground contact waveform groups 33 and 34 indicating the time-series data X(t). The ground contact waveform group 33 and the ground contact waveform group 34 have the same waveform but different phases. Therefore, the ground contact waveform groups may have different numbers of ground contact waveforms, even if the period is the same. A decrease in the number of ground contact waveforms leads to a decrease in the number of waveforms of the autocorrelation function and may affect the accuracy of the determination of the unevenness. Therefore, the time-series data X(t), which has a period T₂ corresponding to two revolutions of the tire in FIG. 7, preferably has a length equal to an integral multiple of the rotation period of the tire. In the period T₂ corresponding to two revolutions of the tire indicated in FIG. 7, the number of ground contact waveforms 33a and 33b of the ground contact waveform group 33 is the same as the number of ground contact waveforms 34a and 34b of the ground contact waveform group 34.

Consequently, the evaluation accuracy of the autocorrelation function R(τ) can be improved for data at a low speed in which the number of ground contact waveforms is small for the time-series data X(t). The autocorrelation function R(τ) can be evaluated without being affected by the phase of the time-series data X(t).

### Second Example of Road Surface Condition Determining Method

Next, a second example of the road surface condition determining method will be described.

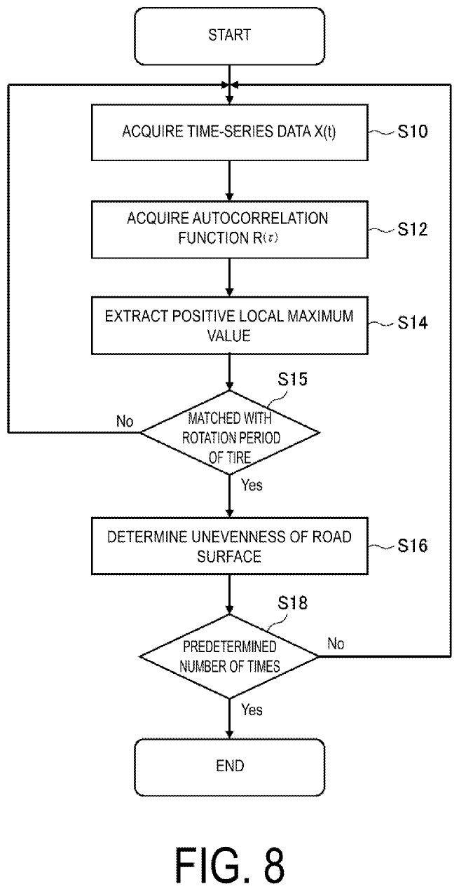

FIG. 8 is a flowchart illustrating a second example of the road surface condition determining method according to the embodiment of the present invention.

In the second example of the road surface condition determining method illustrated in FIG. 8, the same steps as those in the first example of the road surface condition determining method illustrated in FIG. 3 are denoted by the same reference numerals, and detailed description thereof will be omitted.

The second example of the road surface condition determining method is different from the first example of the road surface condition determining method illustrated in FIG. 3 in that the second example of the road surface condition determining method includes a step (step S15) of comparing the position of the positive local maximum value extracted in the third step (step S14) with the rotation period of the tire 12 acquired by a measurement device other than the sensor 14 (see FIG. 1), and the other steps are the same as those of the first example of the road surface condition determining method illustrated in FIG. 3.

In addition, the above-described road surface condition determining device 20, for example, is used in the second example of the road surface condition determining method.

In step S15, for example, the measurement unit 19 illustrated in FIG. 2 measures and acquires the vehicle speed. The information on the vehicle speed is input to the input unit 28 (see FIG. 2) and is output to the processing unit 24 (see FIG. 2). The vehicle speed is converted by the processing unit 24 to obtain the rotation period of the tire 12.

Next, the processing unit 24 compares the position of the positive local maximum value with the rotation period of the tire. When the position of the positive local maximum value is appropriate for the rotation period of the tire as a result of the comparison, the process proceeds to the fourth step (step S16), and the determination of the unevenness of the road surface in the fourth step (step S16) is performed.

On the other hand, when the position of the positive local maximum value is inappropriate for the rotation period of the tire as a result of the comparison, the positive local maximum value is not used for the determination of the unevenness of the road surface in the fourth step (step S16). Then, the process returns to the first step (step S10), and the first step of obtaining the time-series data X(t) when the tire 12 has rotated at least twice is performed, and the process is performed up to the third step (step S14).

When the variation of the time-series data X(t) is large, there is a case where the extraction of the positive local maximum value fails. In such a case, the use of the positive local maximum value for the determination of the unevenness of the road surface is not preferable, since the accuracy of the determination of the unevenness of the road surface decreases. By performing step S15 as described above, it is possible to suppress a decrease in the accuracy of the determination of the unevenness of the road surface.

Here, the rotation period of the tire can be calculated from the vehicle speed acquired by a measurement device other than the sensor and the size of the tire. Further, the period tp of the positive local maximum value (see FIG. 4(b) and FIG. 5(b)) is obtained from the position of the positive local maximum value. Therefore, the comparison between the position of the positive local maximum value and the rotation period of the tire is, for example, the comparison between the period tp of the positive local maximum value obtained from the position of the positive local maximum value and the rotation period of the tire.

If a value represented by 8=((period tp of positive local maximum value)/(rotation period of tire))×100(%) is, for example, 90 to 110%, it is determined that the value is appropriate.

The position of the positive local maximum value being appropriate for the rotation period of the tire means that a deviation between the period tp of the positive local maximum value obtained from the position of the positive local maximum value and the rotation period of the tire is small, and also means that a difference between the vehicle speed obtained from the positive local maximum value and the vehicle speed obtained by a measurement instrument other than the sensor is small.

The comparison between the position of the positive local maximum value described above and the rotation period of the tire is performed by the processing unit 24 (see FIG. 2). For example, the mathematical expression of 8 described above is stored in the storage unit 27, and the vehicle speed measured by the measurement unit 19 is input via the input unit 28 to obtain the rotation period of the tire. The mathematical expression of 8 described above is read from the storage unit 27, and the position of the positive local maximum value described above and the rotation period of the tire are compared.

Also in the second example of the road surface condition determining method, the unevenness of the road surface on a spatial scale longer than the circumferential length of the tire can be determined by using the positive local maximum value.

Also in the second example of the road surface condition determining method, in addition, the time-series data X(t), the autocorrelation function R(τ), the value of the positive local maximum value, and the determination result of the unevenness of the road surface can be displayed on the display unit 21a of the road surface condition determining device 20 described above, for example.

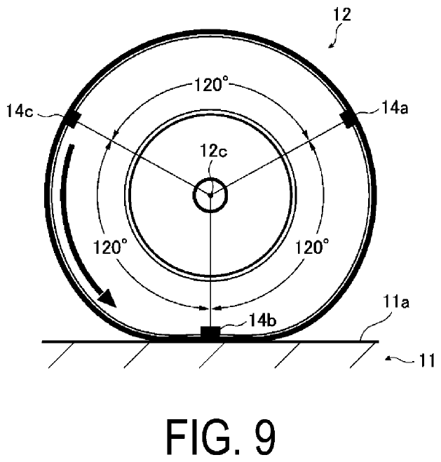

FIG. 9 is a schematic diagram illustrating an example of a tire in which three sensors are disposed.

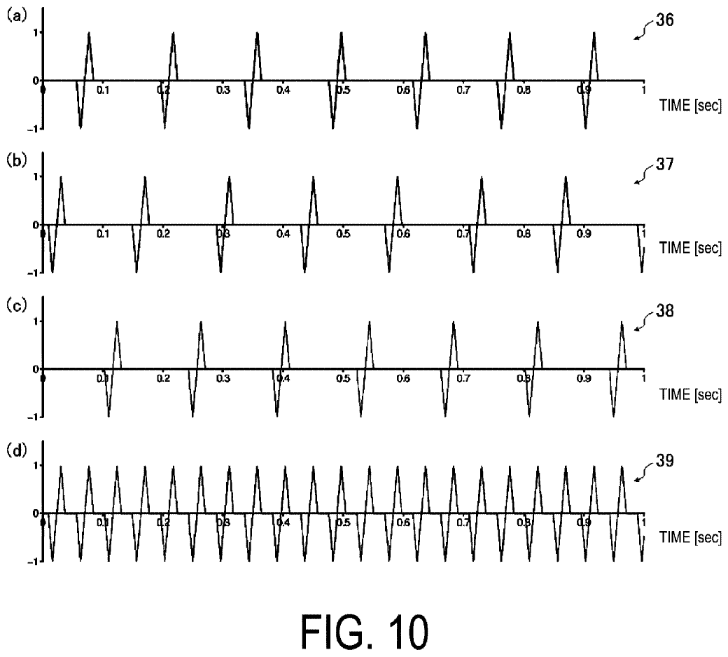

FIG. 10(a) is a graph indicating an example of time-series data obtained by a first sensor, FIG. 10(b) is a graph indicating an example of time-series data obtained by a second sensor, FIG. 10(c) is a graph indicating an example of time-series data obtained by a third sensor, and FIG. 10(d) is a graph indicating an example of a composite waveform of the time-series data obtained by the first sensor to the time-series data obtained by the third sensor.

The sensor 14 (see FIG. 1) is disposed on the inner surface of the tire 12. The number of sensors 14 may be at least one but may be two or more. When a plurality of sensors are disposed, it is preferable to dispose the sensors evenly in the circumferential direction of the tire, since the unevenness of the road surface can be evaluated on a scale of 1/(number of sensors) of the circumferential length of the tire 12.

While the number of sensors may be two, three, or four, the upper limit of the number of sensors 14 is 20, for example, since as the number of sensors 14 increases, the amount of signal processing also increases.

As illustrated in FIG. 9, for example, a first sensor 14a, a second sensor 14b, and a third sensor 14c are disposed at equal intervals along the circumferential direction in one tire 12. In this case, the first sensor 14a, the second sensor 14b, and the third sensor 14c are disposed at intervals of 120° with respect to the rotation axis 12c of the tire 12.

In this case, the acquisition unit 22 acquires an output waveform 36 indicated in FIG. 10(a) as the time-series data X(t) from the first sensor 14a. The acquisition unit acquires an output waveform 37 indicated in FIG. 10(b) as the time-series data X(t) from the second sensor 14b. The acquisition unit acquires an output waveform 38 indicated in FIG. 10(c) as the time-series data X(t) from the third sensor 14c.

The acquisition unit 22 sums up the waveforms 36 to 38 indicated in FIGS. 10(a) to 10(c) to obtain a composite waveform 39 of the time-series data obtained by the first sensor 14a to the time-series data obtained by the third sensor 14c indicated in FIG. 10(d). By using the composite waveform 39 as the time-series data X(t), the unevenness of the road surface can be determined by the first example of the road surface condition determining method or the second example of the road surface condition determining method as described above.

When the number of sensors is two, the sensors are disposed at intervals of 180° with respect to the rotation axis 12c of the tire 12, and when the number of sensors is four, the sensors are disposed at intervals of 90°.

When the composite waveform 39 is used as the time-series data X(t) for the determination of the unevenness of the road surface, the unevenness of the road surface can be evaluated on a scale of ⅓ of the circumferential length of the tire 12, since three sensors are disposed at equal intervals in the circumferential direction of the tire 12. When the number of the sensors 14 is one, the unevenness of the road surface can be evaluated by using information on a scale of the tire circumferential length at the minimum. In the case of FIG. 1, the unevenness of the road surface is determined on a spatial scale longer than the circumferential length of the tire. However, by disposing a plurality of sensors 14, the unevenness can be determined on a spatial scale shorter than the circumferential length of the tire 12.

The signal output from the sensor as described above is a signal including information on acceleration, a strain rate, or strain, and examples of the signal include the following.

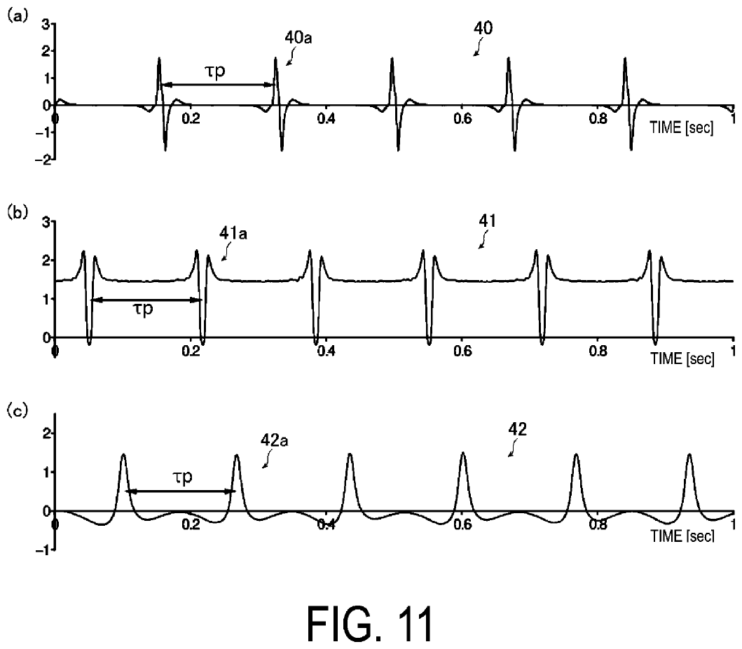

FIG. 11(a) is a graph indicating a first example of an output of a sensor, FIG. 11(b) is a graph indicating a second example of an output of a sensor, and FIG. 11(c) is a graph indicating a third example of an output of a sensor.

FIG. 11(a) indicates an output waveform 40 obtained by a sensor that outputs a signal including information on the strain rate. The output waveform 40 has a pattern similar to that of the ground contact waveform 15a of the ground contact waveform group 15 indicated in FIG. 4(a). A ground contact waveform 40a of the output waveform 40 has a pattern having a peak and a valley.

FIG. 11(b) indicates an output waveform 41 obtained by a sensor that outputs a signal including information on the acceleration. A ground contact waveform 41a of the output waveform 41 has a pattern having a peak, a valley, and a peak.

FIG. 11(c) indicates an output waveform 42 obtained by a sensor that outputs a signal including information on the strain. A ground contact waveform 42a of the output waveform 42 has a pattern having a peak.

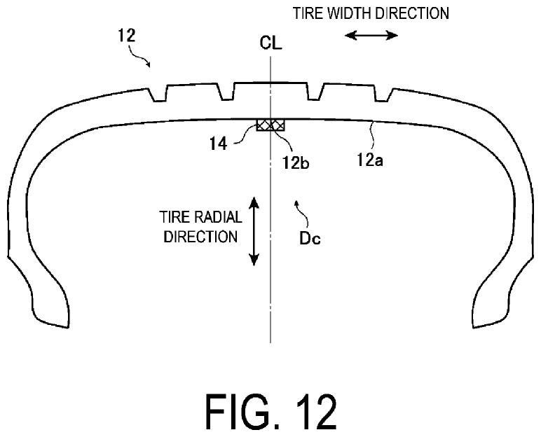

Here, FIG. 12 is a schematic cross-sectional view illustrating an attachment position of a sensor on a tire.

The arrangement position of the sensor 14 is not particularly limited but is preferably, for example, a center 12b of an inner surface 12a of the tire 12 as illustrated in FIG. 12. This makes it easier to acquire information including radial acceleration, a strain rate, or strain of the tire, that is, information including the acceleration in the radial direction of the tire, the strain rate, or the strain.

For a four-wheeled vehicle, the sensor 14 may be disposed in one, two, or three of the four tires, or may be disposed in all the tires. In this case, the number of the sensors 14 is not limited to one for each of the four tires, and a plurality of the sensors 14 may be provided. When a plurality of sensors are disposed, the number of sensors disposed in each tire is preferably the same in order to suppress variation in the accuracy of the determination of the unevenness.

There are no particular limitations on the structure of the tire 12, including the internal structure thereof.

The “tire width direction” as indicated by arrows in FIG. 12 refers to the direction parallel with the rotation axis (not illustrated) of the tire, and the “tire radial direction” refers to the direction orthogonal to the rotation axis. The “tire circumferential direction” refers to the direction in which the tire rotates about the rotation axis.

Further, the “tire inner side” refers to a lower side of the tire in FIG. 12 in the tire radial direction, that is, an inner surface side of the tire facing a cavity region Dc that gives a predetermined internal pressure to the tire, and the “tire outer side” refers to an upper side of the tire in FIG. 12, that is, an outer surface side of the tire visible to a user on an opposite side of an inner circumferential surface of the tire. A reference sign CL of FIG. 12 denotes a tire equatorial plane. The tire equatorial plane CL is a plane orthogonal to the rotation axis of the tire 12 and passing through a center of a tire width of the tire 12.

A tread pattern is formed in a tread surface on the tire outer side by tread grooves and land portions.

The present invention is basically configured as described above. The road surface condition determining method and the road surface condition determining device according to the present invention have been described in detail above. However, the present invention is not limited to the above-described embodiment, and it is needless to say that various improvements or modifications may be made without departing from the gist of the present invention.

### EXAMPLE

Hereinafter, the features of the present invention will be described in more detail with reference to an example of the road surface condition determining method according to the present invention. Materials, reagents, amounts and proportions of substances, operations, and the like described in the following example can be appropriately changed without departing from the gist of the present invention. Thus, the scope of the present invention is not limited to the following example.

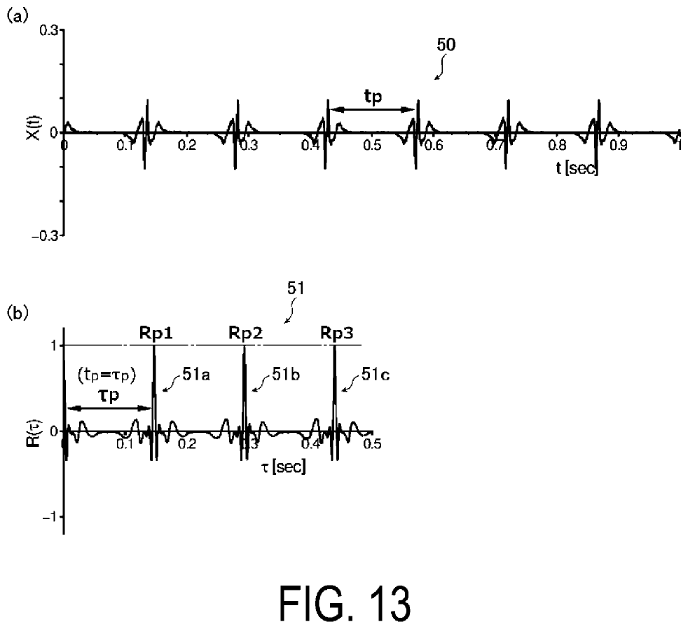

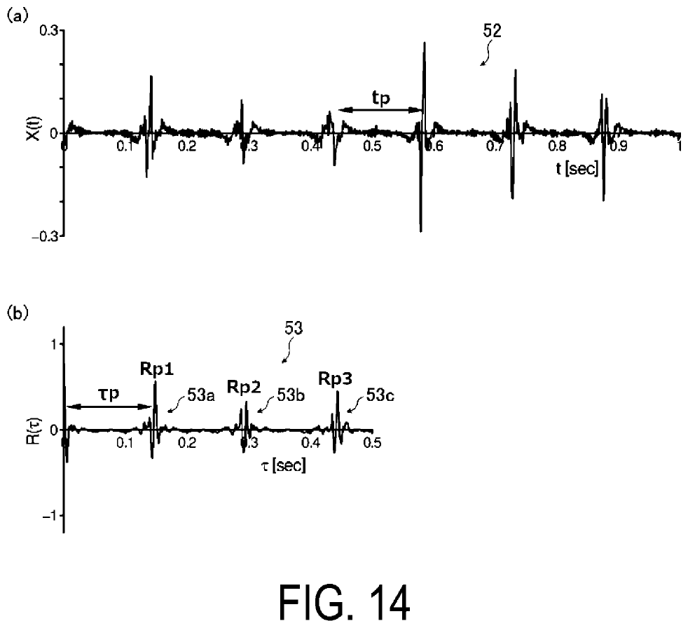

FIG. 13(a) is a graph indicating time-series data X(t) from a sensor on a flat road surface in Example 1, and FIG. 13(b) is a graph indicating an autocorrelation function of the time-series data X(t) of FIG. 13(a). FIG. 14(a) is a graph indicating time-series data X(t) from a sensor on an uneven road surface in Example 1, and FIG. 14(b) is a graph indicating an autocorrelation function of the time-series data X(t) of FIG. 14(a).

### Example 1

In the road surface condition determining method, a strain rate sensor was used. The strain rate sensor was provided at the center 12b of the inner surface 12a of the tire 12 as illustrated in FIG. 12.

A tire having a tire size of 225/45ZR18 was used as the tire and was inflated to a test internal pressure of 230 kPa.

The inflated tire was subjected to the road surface condition determining method under a condition corresponding to a speed of 50 km/hour by using a drum testing machine simulating a smooth road surface.

Further, the inflated tire was subjected to the road surface condition determining method under a condition corresponding to a speed of 50 km/hour by using a drum testing machine simulating an irregular road surface.

In the above-described drum testing machine with a smooth road surface, a ground contact waveform group 50 was obtained as the time-series data X(t) indicated in FIG. 13(a). Then, an autocorrelation function 51 indicated in FIG. 13(b) was obtained from the time-series data X(t). In three waveforms 51a, 51b, and 51c of the autocorrelation function 51, the positive local maximum values Rp1, Rp2, and Rp3 were all 1. This indicates that the road surface is flat without any change in the positive local maximum values.

In addition, in the above-described drum testing machine with an irregular road surface, a ground contact waveform group 52 was obtained to be the time-series data X(t) indicated in FIG. 14(a). Then, an autocorrelation function 53 indicated in FIG. 14(b) was obtained from the time-series data X(t). In three waveforms 53a, 53b, and 53c of the autocorrelation function 53, the positive local maximum values Rp1, Rp2, and Rp3 were all smaller than 1. This indicates that the road surface is irregular, rather than being flat, with a change in the positive local maximum values. In this way, it was possible to determine the unevenness of the road surface by the road surface condition determining method.

### REFERENCE SIGNS LIST

10 Vehicle
11 Road surface
11a Surface
12 Tire
12a Inner surface
12b Center
12c Rotation axis
14 Sensor
14a First sensor
14b Second sensor
14c Third sensor
15, 17, 30, 33, 34, 50, 52 Ground contact waveform group
15a, 17a, 33a, 33b, 34a, 34b Ground contact waveform
16, 18, 51, 53 Autocorrelation function
16a, 16b, 16c, 18a, 18b, 18c Waveform
19 Measurement unit
20 Road surface condition determining device
21 Processing unit
21a Display unit
22 Acquisition unit
24 Processing unit
26 Determination unit
27 Storage unit
28 Input unit
29 Control unit
31 Waveform
32 Autocorrelation function
32a, 32b, 32c, 51a, 51b, 51c, 53a, 53b, 53c Waveform
36, 37, 38, 40, 41, 42 Output waveform
39 Composite waveform
CL Tire equatorial plane
D Traveling direction
Dc Cavity region
T₂ Period

1. A road surface condition determining method, comprising:
a first step of acquiring over time a signal including information on acceleration, a strain rate, or strain output from a sensor disposed on an inner surface of a tire when the tire rolls on a road surface and obtaining time-series data X(t) when the tire has rotated at least twice;
a second step of obtaining an autocorrelation function R(τ), where t is time, from the time-series data X(t) obtained in the first step;
a third step of extracting positive local maximum values having a predetermined magnitude or more at τ>0 for the autocorrelation function R(τ) obtained in the second step; and
a fourth step of determining unevenness of the road surface by using the positive local maximum values extracted in the third step.

2. The road surface condition determining method according to claim 1, wherein the fourth step comprises determining the unevenness of the road surface by using a positive local maximum value closest to τ=0 in the autocorrelation function R(τ) among the positive local maximum values extracted in the third step.

3. The road surface condition determining method according to claim 1, wherein
positions of the positive local maximum values extracted in the third step are compared with a rotation period of the tire acquired by a measurement device other than the sensor,
the fourth step of determining the unevenness of the road surface is performed when the positions of the positive local maximum values extracted are appropriate for the rotation period of the tire; and
the positive local maximum values are not used for the fourth step of determining the unevenness of the road surface when the positions of the positive local maximum values extracted are inappropriate for the rotation period of the tire.

4. The road surface condition determining method according to claim 1, wherein time-series data X(t) having a length equal to an integral multiple of a rotation period of the tire is used.

5. The road surface condition determining method according to claim 1, wherein the positive local maximum values extracted in the third step are 0.1 or more.

6. The road surface condition determining method according to claim 1, wherein
a plurality of the sensors are disposed evenly in a circumferential direction of the tire, and
the first step comprises obtaining the time-series data X(t) by summing up the signal including the information on the acceleration, the strain rate, or the strain from each of the sensors.

7. The road surface condition determining method according to claim 1, wherein
a plurality of the tires are provided, and
the sensor is provided in each of the tires.

8. A road surface condition determining device, comprising:
a sensor disposed on an inner surface of a tire when the tire rolls on a road surface;
an acquisition unit configured to acquire over time a signal including information on acceleration, a strain rate, or strain output from the sensor and obtain time-series data X(t) when the tire has rotated at least twice;
a processing unit configured to obtain an autocorrelation function R(τ), where t is time, from the time-series data X(t) obtained by the acquisition unit and extract positive local maximum values having a predetermined magnitude or more at τ>0 for the obtained autocorrelation function R(τ); and
a determination unit configured to determine unevenness of the road surface by using the positive local maximum values extracted by the processing unit.

9. The road surface condition determining device according to claim 8, wherein the determination unit determines the unevenness of the road surface by using a positive local maximum value closest to τ=0 in the autocorrelation function R(τ) among the positive local maximum values extracted by the processing unit.

10. The road surface condition determining device according to claim 8, wherein
positions of the positive local maximum values extracted by the processing unit are compared with a rotation period of the tire acquired by a measurement device other than the sensor,
the determination unit determines the unevenness of the road surface when the positions of the positive local maximum values extracted are appropriate for the rotation period of the tire, and
the positive local maximum values are not used for the determination unit to determine the unevenness of the road surface when the positions of the positive local maximum values extracted are inappropriate for the rotation period of the tire.

11. The road surface condition determining device according to claim 8, wherein time-series data X(t) having a length equal to an integral multiple of the rotation period of the tire is used.

12. The road surface condition determining device according to claim 8, wherein the positive local maximum values extracted by the processing unit are 0.1 or more.

13. The road surface condition determining device according to claim 8, wherein
a plurality of the sensors are disposed evenly in a circumferential direction of the tire, and
the acquisition unit obtains the time-series data X(t) by summing up the signal including the information on the acceleration, the strain rate, or the strain from each of the sensors.

14. The road surface condition determining device according to claim 8, wherein
a plurality of the tires are provided, and
the sensor is provided in each of the tires.

15. The road surface condition determining method according to claim 2, wherein
a plurality of the sensors are disposed evenly in a circumferential direction of the tire, and
the first step comprises obtaining the time-series data X(t) by summing up the signal including the information on the acceleration, the strain rate, or the strain from each of the sensors.

16. The road surface condition determining method according to claim 2, wherein
a plurality of the tires are provided, and
the sensor is provided in each of the tires.

17. The road surface condition determining device according to claim 9, wherein
a plurality of the sensors are disposed evenly in a circumferential direction of the tire, and
the acquisition unit obtains the time-series data X(t) by summing up the signal including the information on the acceleration, the strain rate, or the strain from each of the sensors.

18. The road surface condition determining device according to claim 9, wherein
a plurality of the tires are provided, and
the sensor is provided in each of the tires.
